(19) United States
(12) Patent Application Publication
(10) Pub. No.: US 2008/0320014 A1
(43) Pub. Date: Dec. 25, 2008

(54) Discriminative Feature Selection System Using Active Mining Technique

(76) Inventors: Feng Chu, Singapore (SG); Lipo Wang, Singapore (SG)

Correspondence Address: Feng Chu, BLK 655A, Jurong West Street 61, #15-524, S641655, Singapore, 641655, SG

(21) Appl. No.: 11/767,514

(22) Filed: Jun. 24, 2007

(51) Int. Cl. G06F 7/06; G06F 17/30

(52) U.S. Cl. 707/100; 707/E17.033; 707/E17.014

(57) ABSTRACT

A discriminative feature set (DFS) selection method is described wherein a forward wrapper framework and a self error-correction concept are used. In this approach, the first feature is selected using a statistical measure. After that, the feature that aims to correct the errors made by the current feature set is selected using a measure called correction score (CS) and is subsequently added into the feature set. This error-corrective feature-adding process stops until a required number of features are included into the DFS or a pre-defined accuracy is achieved. According to different levels of error correction, this method has three derivatives for different tasks and data. The speediness and adaptability of this approach make it efficient and effective for high-dimensional discriminative feature selection.

### BACKGROUND OF THE INVENTION

This invention relates to a feature subset selection system that extracts small subsets of features from high-dimensional data for computer-based classifiers to achieve good classification accuracy and efficiency.

Providing a subset of features with good discriminative power (we call it discriminative feature set, or DFS) for a classifier has been an important topic in pattern recognition and machine learning research, especially when the dimensionality of the input space is high. Reducing the dimensionality of the input space will benefit a classifier in the following aspects. (1) it excludes noise and irrelevant features from the classifier and therefore increases the accuracy of the classifier; (2) it reduces the computation load of the classifier and makes the task computationally cheaper.

Popular input dimensionality reduction approaches can be divided into two categories, i.e., feature extraction and feature selection. Feature extraction approaches reconstruct a new feature space to represent the original space but in a lower dimensionality. Popular feature extraction approaches include: principal components analysis, independent components analysis, partial least squares, etc. Feature selection approaches select a number of features from all features in the input space according to a selection criterion (SC), for example, t-statistic, ƒ-statistic, correlation among features, and information gain. A typical feature selection procedure is: a SC is firstly calculated for each feature and then a number of features with the largest SCs are selected for classification. Although both feature extraction and feature selection reduce the dimensionality of a feature space, the former is more capable of capturing the characteristics of a feature space and is therefore more suitable for image processing, visualization, signal processing, and so on. In contrast, the later is more capable of finding out proper features for a specific task (e.g., differentiating samples) and is therefore be more suitable for classification problems.

Feature selection approaches can be further categorized into two models based on whether a classifier is involved. If the SC is classifier-independent, e.g., using t-statistic as the SC, the approach is called a filter. If the SC is classifier-dependent, i.e., the approach selects a subset of features that directly optimize the performance of the classifier, the approach is called a wrapper. Although wrapper approaches are generally much more computationally expensive than filter approaches, wrapper approaches usually yield better feature subsets that achieve better prediction accuracy and usually with less redundancy than filter approaches. Due to these obvious advantages, a variety of wrapper approaches have been proposed based on different types of classifiers, e.g., neural networks, decision trees, linear discriminant analysis, and support vector machines (SVMs) disclosed in U.S. Pat. No. 5,649,068 (B. Boser, 1. Guyon, and V. Vapnik).

During the process of feature subset selection, if a wrapper approach eliminates features from the original feature space repeatedly until a resulting subset is obtained, it is called a “backward” selection, on the contrary, if a wrapper adds features to a null subset repeatedly until a resulting subset is obtained, it is called a “forward” selection. Usually, a backward selection approach is better than its forward counterpart in terms of the quality of the selected feature subset (see e.g., “Selection bias in gene extraction on the basis of microarray gene-expression data” (C. Ambroise and G. J. McLachlan) PNAS 99:6562-6566). Therefore, the backward selection, e.g., the widely used SVM-based recursive feature elimination (SVM-RFE) proposed in “Gene selection for cancer classification using support vector machines” (I. Guyon, J. Weston, S. Barnhill, and V. Vapnik) Machine Learning 46:389-422, becomes the mainstream for wrappers.

However, a major limitation of backward wrappers compared with forward wrappers is their high computational cost, especially when selecting feature subsets from a high-dimensional space. For example, using microarray gene expression data to differentiate tumors could be such a problem, which typically requires to one select a few tens of features from thousands of candidates. In such cases, forward wrappers could be much faster than backward wrappers.

### SUMMARY OF THE INVENTION

The present invention directs to a computationally efficient approach for selecting discriminative feature subsets for pattern classification and recognition. This approach is capable of obtaining features recursively according to the “needs” of the current feature subset. This adaptability for feature selection is somewhat analogous to the pool-based active learning for data selection (see e.g., “Support vector machine active learning with applications to text classification” (S. Tong and D. Koller) Journal of Machine Learning Research 2:45-66). Hence, we call our approach active mining discriminative feature sets (AM-DFS). The major difference between the AM-DFS and the pool-based active learning is as follows. The AM-DFS uses its adaptability to search for discriminative features. In other words, the objective of the AM-DFS is to maximize the discriminating ability of the DFS selected from the training data. From function point of view, this adaptability makes the AM-DFS an error-correction process. In contrast, the pool-based active learning uses its adaptability to search for “unlabelled” data samples. In other words, the objective of the pool-based active learning is to obtain more and quality samples for the training process.

The AM-DFS combines the error correction ability of our AM paradigm and the speediness of the forward wrapper. Furthermore, since the working principle of the AM-DFS does not rely on a specific classifier model, the AM-DFS can be easily adapted to different classifiers based on the tasks and the characteristics of the data.

The AM-DFS can start the search from any feature. Therefore, when we apply it to a number of features, we obtain a DFS for each of the initial feature sets. In contrast, other feature selection approaches usually obtain only one or much fewer DFSs as a result of search.

The AM-DFS has three different derivatives based on different levels of error correction, which makes it flexible for different tasks and data.

### BRIEF DESCRIPTION OF THE DRAWINGS

FIG. 1 illustrates the working principle of an active learner (AL).

FIG. 2 illustrates the four types of samples for a classification problem, based on which three derivatives of the AM-DFS are developed.

FIG. 3 illustrates the working principle of an active miner (AAM).

FIG. 4 illustrates an example of A2.

FIG. 5 illustrates two features selected by the AM-DFS and shows effectiveness of the AM-DFS.

### DETAILED DESCRIPTION OF THE PREFERRED EMBODIMENTS

In the present invention, the concept of the self-correction ability is somewhat analogous to the concept of searching for unlabelled samples used in the “pool based active learning”. Therefore, we firstly give a brief introduction to active learning as follows.

An active learner (AL) contains three components {X, F, Q}. X is an input matrix. F is a mapping function from the input space to the output space that realizes the objective (or the function) of the AL. Q is a query function that is used to search and add unlabelled samples (which are usually only used for testing purposes by other learning algorithms) into X. In other words, the AL has the ability to obtain “new knowledge” (i.e., unlabelled samples) that will “benefit” its learning. Compared to passive learners that only contain X and F but no Q, ALs are able to select data for itself based on the learner's present status and therefore has the potential to obtain a better learning result.

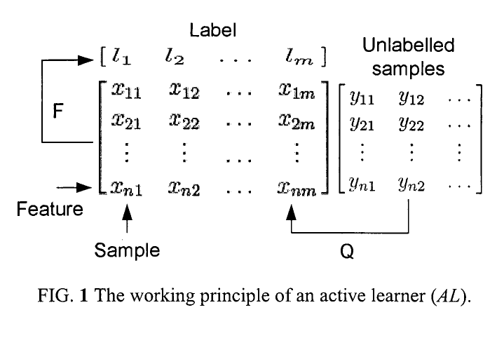

The working principle of an AL is described in FIG. 1. Here the AL firstly uses the query function Q to search for an unlabelled sample and then assign a label to it using the mapping function F. This labelling is like a “bet” made by the AL. However, the AL should take the smallest “risk” to make this “bet”. For example, if F is an SVM classifier, the selected unlabelled sample should have a decision value very close to the assigned label and the SVM should be “safe” to assign the label to this sample. Secondly, the selected sample and the assigned label will be included into X to fit the mapping function F. Obviously, if the label is correctly assigned, the newly fitted F must be better or as good as previously because more correct information is used for the mapping. However, if the label is not correctly assigned, the newly fitted F could be worse than previously because more “noise” affects the mapping.

Some applications of active learning have proved its usefulness to improve the performance of a learner (see, e.g., “Support vector machine active learning with applications to text classification” (S. Tong and D. Koller) Journal of Machine Learning Research 2:45-66).

Although some researchers noticed that a feature selection step prior to or after an active learning approach could enhance its performance (see e.g., “Active learning with feedback on both features and instances” (H. Raghavan, O. Madani, and R. Jones) Journal of machine learning research 7:1655-1686), in almost all the active learning approaches proposed to date, the function Q is for searching for unlabelled samples (i.e., observations or instances) to be learned by the AL. Here we disclose a learning algorithm with a query function Q for searching for features according to the current state of the learner.

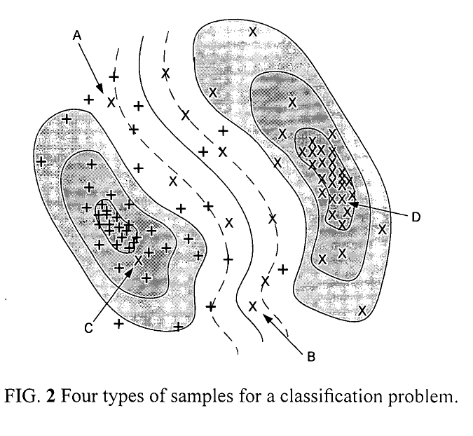

First, we illustrate the four types samples for a classification problem shown in FIG. 2. Here all the “x” samples belong to −1 group and all the “+” samples belong to +1 group. The solid line between the −1 and +1 groups is the decision boundary ƒ(X)=0. A: a wrongly labelled sample, that is, the decision boundary labels A wrongly; B: an unreliable sample, that is, the decision boundary labels B correctly. However, B has a decision value close to 0 (e.g., −0.1) and is very close to the decision boundary; C: an uncorrectable sample, that is, the decision boundary label C wrongly. Furthermore, the decision value for C is close to the wrong label +1 (e.g., +0.9); D: an reliable sample, that is, the decision boundary labels D. Furthermore, the decision value for D is close to the desired label −1 (e.g., −0.9).

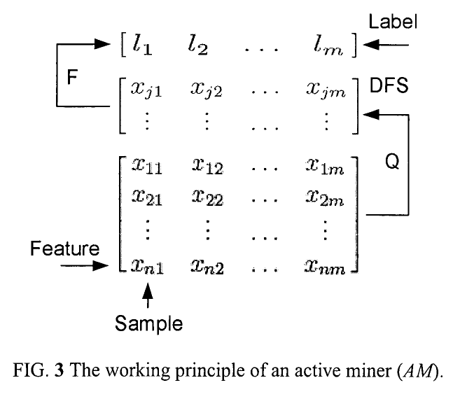

The working principle of our invention is shown in FIG. 3. Our algorithm starts with a feature with good discriminative ability to search for the DFS (This feature is called a seed as introduced in detail later). Then, the AM fits a mapping function, F, from this DFS to the label. After that, a query function Q is used to search for a new feature that can improve the accuracy of F. Here we use three kinds of searching schemes as Q. The first scheme (A1) searches for the feature that aims to correct the errors made by the current DFS; in addition to the routine of A1, the second scheme (A2) adds a step to improve the prediction of “unreliable samples”; in addition to the routine of A2, the third scheme (A3) adds a step to exclude “uncorrectable samples”. From this introduction, it is clear that our algorithm (including its three derivatives) are similar to active learning in its adaptability to “new knowledge”. The difference between active learning and our algorithm is the content of the “knowledge”.

For the present invention, we use it to deal with classification problems. Therefore, the mapping function F is a classifier and the outputs of the learning process are DFSs. The whole process of our algorithm is therefore called active mining discriminative feature sets (AM-DFS) and can be divided into the following steps.

1. Assign a feature as the first member of a DFS.
2. Fit a classifier using the current DFS.
3. Based on the classification result of the current DFS, add a new feature into the DFS to correct errors or enlarge the separation among unreliable samples (introduced in FIG. 2).
Steps 2 and 3 are repeated until a required number of features are included into the DFS or a pre-defined accuracy is achieved.

According to the definition of a DFS, it is obvious that a feature with greater discriminative power is more likely to be included in good DFSs. Therefore, the AM-DFS firstly ranks all the features according to their discriminating capability. Then a number of features with the highest ranks (e.g., the top 20 features) are selected as the initial features in the DFSs, i.e., the seeds of these DFSs. Here we use T-statistic (TS) to illustrate this ranking. The TS of feature i is defined as follows.

$$\begin{matrix}{TS}_{i} = max \{ \vert \frac{{\overline{x}}_{ik} - {\overline{x}}_{i}}{{m}_{k} {s}_{i}} \vert , k = 1 , 2 , … K \} \\ where & ( 1 ) \\ {\overline{x}}_{ik} = {\sum }_{j ∈ {C}_{k}} {x}_{ij} / {n}_{k} & ( 2 ) \\ {\overline{x}}_{i} = {\sum }_{j = 1}^{n} {x}_{ij} / n & ( 3 ) \\ {s}_{i}^{2} = \frac{1}{n - K} {\sum }_{k} {\sum }_{j ∈ {C}_{k}} {( {x}_{ij} - {\overline{x}}_{ik} )}^{2} & ( 4 ) \\ {m}_{k} = \sqrt{\frac{1}{{n}_{k}} - \frac{1}{n}} & ( 5 )\end{matrix}$$

There are K classes. max{yₖ, k=1, 2, . . . K} is the maximum of all yₖ. Cₖ refers to class k that includes nₖ samples. xᵢⱼ is the value of feature i in sample j. x̅ᵢₖ is the mean value in class k for feature i. n is the total number of samples. x̅ᵢ is the general mean value for feature i. sᵢ is the pooled within-class standard deviation for feature i. In fact, the TS used here is a t-statistic between the centroid of a specific class and the overall centroid of all the classes.

Although a seed with a high TS rank is more likely to lead to a good DFS, it does not mean that the No. 1 seed will necessarily lead to the best DFS. In fact, the best DFS may come from No. 5 or No. 10 seed. Therefore, we use a number of top features (e.g., top 20 features) as seeds to search for DFSs, which will greatly increase our possibility to find the best DFSs.

As mentioned previously, any classifier, e.g., a SVM and an artificial neural network, can be adapted to the AM-DFS. If the function of the classifier is ƒ(X), then we call the value of ƒ(Xₗ) is the decision value of the samples Xₗ.

We define a ranking scheme, which we call correction score (CS), to measure a feature's ability to separate the misclassified samples. The CS of feature i is defined as:

$$\begin{matrix}{CS}_{i} = {S}_{bi} / {S}_{wi} \\ where & ( 6 ) \\ {S}_{bi} = {\sum }_{k} {\sum }_{j ∈ {C}_{K}} {( {e}_{ij} - {\overline{x}}_{ik} )}^{2} & ( 7 ) \\ {S}_{wi} = {\sum }_{k} {\sum }_{j ∉ {C}_{k}} {( {e}_{ij} - {\overline{x}}_{ik} )}^{2} & ( 8 )\end{matrix}$$

where eᵢⱼ is the values of feature i in the wrongly labelled samples (or together with unreliable samples) in Cₖ. x̅ᵢₖ is defined in Eq. 2. S_{bi} is the sum of squares of the inter-class distances (the distances among samples belonging to different classes) among the wrongly labelled samples. S_{wi} is the sum of squares of the intra-class distances (the distances among samples within the same class) among the wrongly labelled samples. A larger CS indicates a greater ratio of the inter-class distance to the intra-class distance, and therefore a higher ability of a feature to separate the selected samples.

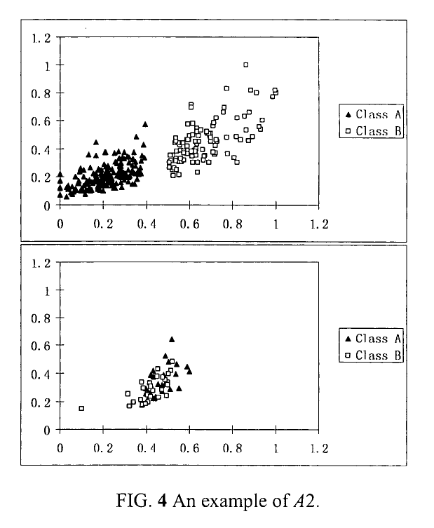

If we also consider unreliable samples and uncorrectable samples when calculating the CS, the AM-DFS can be derived into three forms. For the first derivative (we call it algorithm 1, or A1), only wrongly labelled samples are used in calculating the CS. In other words, A1 searches for the next feature that only tries to correct the errors made in the previous round of training (Here we define a process of picking out a feature and adding it into a DFS as a round of training). For the second derivative (we call it algorithm 2, or A2), both wrongly labelled samples and unreliable samples are used in calculating the CS. In other words, A2 searches for the next feature that not only tries to correct the errors but also tries to enlarge the separation among those unreliable samples. FIG. 4 shows an example of A2, in which the CS is used to wrongly labelled samples and unreliable samples. Here all the samples belong to two classes: squares with label “+1” and triangles with label “−1”. In the upper figure, we plot the samples that receive prediction values ≧0.8 or ≦−0.8. In the lower figure, we plot the samples that receive the prediction values between −0.8 to 0.8 together with the samples receiving wrong prediction. The CS is calculated to separate the samples in the lower figure.

For the third derivative (we call it algorithm 3, or A3), uncorrectable samples are excluded from the process of searching for the next features. In other words, A3 tries to exclude the influence of “possible noise”. The whole process of A1, A2, and A3 is given below.

Algorithm: AM-DFS

Inputs:
Training samples: Xₜᵣ = [xₜᵣ₁, xₜᵣ₂, ..., xₜᵣₗ]^{T}, testing samples Xₜₑₛₜ
Class labels for training and testing samples: Yₜᵣ = [yₜᵣ₁, yₜᵣ₂, ..., yₜᵣₗ]^{T}, Yₜₑₛₜ
The number of seeds to be used for searching for DFSs: M
The number of features to be included in a DFS: N
Initialize:
Initialize a DFS to an empty matrix: DFS=[ ].
Choose a seed:
Calculate the TS for each feature in Xₜᵣ.
for(m = 1;until m < M; m + +)
{
Select a feature with the m-th largest TS as the seed (S).
S →DFS.
Repeat until: N features are left in the DFS or the Error rate Eₜᵣ is
less than a pre-defined value:
{
Train an SVM with DFS then obtain Eₜᵣ.
Pick out the misclassified samples Xₑ = [xₑ₁, xₑ₂, ..., xₑₜ]^{T}.
{Pick out the UNRELIABLE SAMPLES and put them into Xₑ if
they are not already there. /*this step is only used in the A2 and A3*/}
{Pick out the POSSIBLE NOISE SAMPLES and delete them from
Xₑ /*this step is only used in the A3*/}
Calculate CS for each feature in Xₑ.
Pick out the feature with the largest CS and put it into the DFS.
}
}
Output
DFSs

Since each seed leads to a DFS, our algorithm usually outputs a number of DFSs (e.g., 20 DFSs when we use 20 seeds for searching). When a DFS is used as a predictor, one needs to select a DFS with good generalization capability from all the obtained DFSs. Here, we use cross validation (CV) to do this selection. That is, we carry out CV (e.g., 10-fold CV) for the training samples for each DFS and then select the DFS that achieves the highest accuracy to build the predictor.

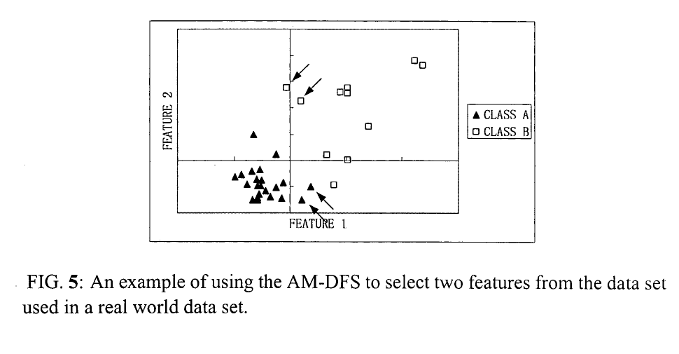

FIG. 5 shows an example of using AM-DFS to select a two feature DFS, which clearly shows the effectiveness of the AM-DFS. First, the seed (FEATURE 1) classified all the samples correctly except the four samples pointed by arrows. After that, the AM-DFS selected FEATURE 2 to separate these four wrongly labelled samples. Therefore, these two features jointly classify the two types of samples perfectly.

What is claimed is:

1. A feature selection method for a computer-based classification system comprising the steps of:
(a) ranking each feature's discriminating ability in the input feature space; and
(b) picking out a top-ranking feature as the first member of a DFS, i.e., the seed; and
(c) classify the training samples using the current DFS as the input features; and
(d) using the wrongly labelled samples to form a pool of “to-be-corrected” samples; and
(e) ranking each feature's discriminating ability using the “to-be-corrected” samples; and
(f) picking out the top-ranking feature and adding it into the DFS; and
(g) repeating the steps (d) to (g) until a required number of features are included into the DFS or a pre-defined accuracy is achieved.

2. The method of claim 1, wherein the decision value is used to categorize the samples into wrongly labelled samples, samples, unreliable samples, uncorrectable samples, and reliable samples according to rules illustrated in FIG. 2; and

3. The method of claim 2, wherein both the wrongly labelled samples and the unreliable samples are used to form the pool of “to-be-corrected” samples at step (e); and

4. The method of claim 3, wherein the uncorrectable samples are excluded from the “to-be-corrected” samples at step (e); and

5. The method of claim 1, wherein the t-statistic is used as the ranking scheme to select the seed of a DFS; and

6. The method of claim 1, wherein the correction score (CS) is used as the ranking scheme at step (f), and

7. The method of claim 1, wherein a number of top-ranking features are selected as the seed in step (b) to search for DFSs; and

8. The method of claim 7, wherein the cross-validation rate is used to evaluate the quality of the resulting DFSs; and

9. The method of claim 8, wherein the DFS that achieved the highest cross-validation accuracy is used to build the prediction model.
